(19) United States
(12) Patent Application Publication
(10) Pub. No.: US 2005/0034484 A1
(43) Pub. Date: Feb. 17, 2005

(54) Preparing preforms for fibre fabrication

(76) Inventors: Maryanne Candida Jane Large, New South Wales (AU); Alexander Argyros, New South Wales (AU); Joseph Zagari, New South Wales (AU); Ian Andrew Maxwell, New South Wales (AU); Martijn Alexander van Eijkelenborg, New South Wales (AU); Nader Issa, New South Wales (AU)

Correspondence Address: WOLF GREENFIELD & SACKS, PC;FEDERAL RESERVE PLAZA, 600 ATLANTIC AVENUE, BOSTON, MA, 02210-2211, US

(21) Appl. No.: 10/484,273

(22) PCT Filed: Jul. 22, 2002
(86) PCT No.: PCT/AU02/00977

(30) Foreign Application Priority Data
Jul. 20, 2001 (AU) PR 6492
Jul. 20, 2001 (AU) PR 6495
Jul. 20, 2001 (AU) PR 6493

(51) Int. Cl. C03B 37/075

(52) U.S. Cl. 65/392; 65/393; 264/1.27; 264/1.24

(57) ABSTRACT

This invention relates to a method of producing a preform for an optical fibre. More particularly, the present invention relates to a method of preparing preforms for the production of holey optical fibres. The invention provides a method of producing an optical fibre, said method comprising applying heat to the interior of a preform and subsequently drawing said optical fibre from said preform. The invention also provides a method of producing an optical fibre, said method comprising preparing a preform comprising a body of optically suitable material and removing material at predetermined locations in the body so as to provide a plurality of holes within the body, applying heat to the interior of the preform and subsequently drawing said optical fibre from said preform.

### FIELD OF THE INVENTION

This invention relates to a method of producing a preform for an optical fibre. More particularly, the present invention relates to a method of preparing preforms for the production of holey optical fibres. Whilst the invention has particular application in the manufacture of optical fibre from polymer or glass materials, it should be appreciated that the invention can be applied in producing optical fibre from any form of suitable material.

### BACKGROUND TO THE INVENTION

Any discussion of the prior art throughout the specification should in no way be considered as an admission that such prior art is widely known or forms part of common general knowledge in the field.

Glass Microstructured Optical Fibres (MOFs) (also known as “photonic crystal fibres” or “holey fibres”) were first developed in 1974 by Bell labs. They have attracted much more attention since 1996 when a group from the University of Bath published a paper on an “endlessly” singlemode photonic crystal fibre and a large effort has been devoted throughout the world researching their guiding properties and developing new devices. MOF's guide light in the core using an array of microscopic holes that extend along the entire length of the fibre. By changing the hole structure, a large range of fibre properties such as dispersion, birefringence and nonlinearities can be tailored to the required application.

The first single mode Microstructured Polymer Optical Fibre (OF) operating in the visible optical spectrum was reported in 2001 by Martijn A. van Eijkelenborg, Maryanne C. J. Large, Alexander Argyros, Joseph Zagari, Steven Manos, Nader A. Issa, Ian Bassett, Simon Fleming, Ross C. McPhedran, C. Martijn de Sterke and Nicolae A. P. Nicorovici, in “Microstructured polymer optical fibre”, Optics Express Vol. 9, No. 7, pp. 319-327 (2001). MPOFs can be fabricated with greater flexibility than silica using techniques such as casting and extrusion and hence can offer a greater variety of structures.

It is known to produce optical fibres by means of a drawing process wherein a length of fibre is drawn from an initial preform. It is also known to heat the preform so as to facilitate the drawing process. However, the materials from which optical fibres are typically manufactured are poor heat conductors. This results in a temperature gradient across the cross-section of the preform and subsequently leads to problems in the drawing process which to date has restricted the size of preforms which can be used.

It is therefore an object of the present invention to overcome or ameliorate at least one of the disadvantages of the prior art, or to provide a useful alternative.

### SUMMARY OF THE INVENTION

To this end, one aspect of the present invention provides a method of producing an optical fibre, said method comprising applying heat to the interior of a preform and subsequently drawing said optical fibre from said preform.

Unless the context clearly requires otherwise, throughout the description and the claims, the words ‘comprise’, ‘comprising’, and the like are to be construed in an inclusive sense as opposed to an exclusive or exhaustive sense; that is to say, in the sense of “including, but not limited to”.

Advantageously, by applying heat to the interior of the preform to produce the desired temperature within the interior of the preform the drawing process is assisted. This in turn facilitates the use of larger sized preforms.

In one preferred embodiment, the preform includes one or more holes which facilitate the heating of the interior of the preform by the application of a heating fluid. More particularly, the holes in the preform permit the ingress of the heating fluid into the preform to facilitate the heating of the interior of the preform. The heating fluid may comprise either a liquid or a gas, although in a practical embodiment of the invention a gas is preferred.

A further aspect of the present invention provides a method of producing an optical fibre, said method comprising applying heat to both an exterior surface and the interior of the preform and subsequently drawing said optical fibre from said preform.

A further aspect of the present invention provides a method of producing an optical fibre, said method comprising drawing said optical fibre from a preform wherein both an exterior surface and interior of the preform are heated to assist in drawing the preform.

A further aspect of the present invention provides a method of preparing a preform for a holey fibre comprising providing a body of optically suitable material and removing material at predetermined locations in said body so as to provide a plurality of holes within the body.

Whilst the various aspects of the present invention are particularly applicable to the process of making polymer holey fibres, it is to be noted that they are also applicable to the production of fibres made from other materials, such as glass. The present invention is particularly suitable for producing holey fibres or photonic crystal fibres. These fibres contain, for example, a plurality of mutually parallel, longitudinally extending holes arranged generally around the fibre axis.

Advantageously, the holes in the preform serve not only their ultimate functional purpose in the optical fibre, but also serve as conduits for the heating fluid in the preform. This assists in achieving a suitable temperature gradient across the cross-section of the preform for drawing of the preform.

Another surprising advantage has arisen from the present invention insofar as the invention has permitted the use of relatively large preforms (that is, preforms of 50 mm diameter or greater) in comparison with conventional preforms. The preform is heated by the aforementioned technique, and then drawn. This provides a number of significant advantages over the prior art. For example, the increase in size and volume of the preform increases the length of optical fibre which can be ultimately drawn from the preform. In turn this provides advantages by reducing the number of fibre connections necessary for long distance optic fibre installations, such connections being a potential source of leakage.

Additionally, by being able to use preforms of a larger size, it is possible to incorporate a greater number of holes into the cross-section of the preform, thereby increasing the possibilities for the design of an optical fibre with desired transmission characteristics. Alternatively, by using a larger preform more cladding material can be provided around the central core structure of the preform, which enhances the protection of the core structure.

Additionally, the present invention enables a large draw ratio which in turn leads to a reduction in the defect size in the resulting optical fibre.

Furthermore, as a result of being able to use relatively large preforms a variety of industrial techniques can be used to produce the preform rather than the more demanding and specialised techniques required when working with very small scaled preform structures.

### BRIEF DESCRIPTION OF THE DRAWINGS

Preferred embodiments of the invention will now be described, by way of example only, with reference to the accompanying drawings in which:

FIG. 1 illustrates the cross-section of a preform fabricated in accordance with the present invention;

FIG. 2 illustrates the cross-section of the resulting optical fibre drawn from the preform illustrated in FIG. 1;

FIG. 3 illustrates the graded refracted index profile of the optical fibre illustrated in FIG. 2;

FIG. 4 illustrates the cross-sectional profile of a preform design which was the subject of experimental trials conducted by the applicant;

FIG. 5 illustrates the experimental set up used in the experimental trials;

FIG. 6 shows a comparison between simulated and measured temperature profile data resulting from the trial;

FIG. 7 illustrates a temperature contour plot across the cross-section of the preform; and

FIG. 8 is a graph of the radial temperature profiles across the preform at different heating times and illustrating a comparison between solid and structured preforms.

### DESCRIPTION OF PREFERRED EMBODIMENTS

A number of preferred aspects of the invention will now be described, by way of example only.

In one embodiment of the invention the preform includes a plurality of holes so as to permit ingress of a heated fluid to heat the interior of the preform. In one preferred embodiment the holes in the preform have parallel axes and extend parallel to the principal axis of the preform. It is further preferable for the holes to extend through the preform. In such an embodiment, the heated fluid can pass through the preform so as to heat the interior of the preform.

In another embodiment of the invention, the holes in the preform may be heated by pins or protrusions instead of heated air or other fluid. In this embodiment, the pins are heated and inserted into the holes in the preform to produce the desired temperature gradient across the preform to facilitate the subsequent drawing process. In one embodiment, such pins or protrusions can form part of a mould in which the first stage preform is cast.

In a further embodiment, lasers may be used to provide heating to the interior of the first stage preform. For example, several lasers may be used such that they intersect at the interior portion of the preform thereby providing a cumulative heating effect within the preform.

In a further embodiment, heating of the interior of the preform may be achieved by the application of radiation falling within the absorption bands of the material. Radiation in the form of microwaves or infrared may be employed.

In one preferred embodiment, the invention provides a multi-stage method of producing structured preforms, which can be drawn into holey fibres. A relatively large diameter initial preform is heated both internally, using holes in the preform to duct hot air, and locally from the outside. This is then drawn down to second stage preform of a size that can be drawn by conventional means. The large initial diameter of the preform means that material removal techniques can be used to make a complex hole structure in the preform that would not be possible if working with a small diameter preform.

A challenge in making polymer holey fibres is to produce very complex structure preforms that can be subsequently drawn into photonic crystal fibres. Experiments conducted by the applicant to date have shown that if a suitably structured preform is fabricated, the structure can be drawn into a fibre.

The diameter of conventional preforms is limited by the need to maintain a relatively constant temperature across the whole diameter so that the fibre draws evenly. If preforms are made of too large a diameter then the centre of the preform may be at a much lower temperature than the outer, resulting in distortions during the drawing process. However, with the present invention the fact that the preform is holey allows heating to occur both from the interior outwardly, as well as from the exterior inwardly. This can be done, for example, by ducting hot air through the holes, and by also applying heat externally. In one preferred embodiment the process involves a two stage preparation of preforms, initially starting from a much larger diameter than normal, which is then drawn down to a diameter that could be used in a conventional furnace in a drawing tower.

Apart from allowing the preform to be made much larger than previously, there are other advantages that follow from enhanced control of the temperature gradient in the preform. For example, the temperature gradient across the preform may be used as a means of achieving other kinds of gradients in the preform, for example by diffusion. Temperature gradients within the preform can also be used to produce gradients in hole size, and hence refractive index. In general hotter areas will have lower viscosity and hence will allow a relative shrinkage of the holes under the influence of surface tension. Similarly controlled expansion of material within the holes can be used to cause relative hole expansion.

According to a further aspect of the invention, there is provided a method of preparing a preform for a holey fibre comprising providing a body of optically suitable material and removing material at predetermined locations in the body so as to provide a plurality of holes within the body.

Larger preforms allow for greater accuracy in the initial structure and allow a greater variety of methods to be used in producing the preform. For polymers and a variety of softer glasses, these include casting, extrusion, and various methods of material removal.

In one preferred embodiment, the plurality of holes pass through the body. However, it should be noted that it is conceivable for the holes to extend only partially into the body.

In one preferred embodiment, the plurality of holes have parallel axes and are parallel to the principal axis of the preform.

The body of the preform may be formed from any suitable material. In one preferred embodiment, the body is formed from polymeric material. However, it is to be noted that the method of the present invention can also be applied to glass preforms.

The material may be removed from the preform body mechanically, chemically or by any other technique.

For example, the mechanical removal of the material can be accomplished by any suitable technique such as mechanical drilling, sonic drilling, laser micro machining or punching.

One preferred method of removing material from the body of the preform is by means of mechanical drilling. It is to be noted that some care needs to be exercised in removing the material by this method so as to ensure that the polymer material is not overheated, resulting in localised melting or depolymerisation. Furthermore, mechanical drilling induces stresses into the material. Such stresses can manifest themselves in the resulting optical fibre in terms of induced birefringence. Furthermore, the preform can become susceptible to cracking or surface defects. In order to cope with this, an intermediate annealing stage may be employed after the material has been removed from the body of the preform but prior to the drawing of the preform.

In one possible embodiment of the invention, pins are inserted into the preform body at the desired locations so as to form the required holes. In this technique, the material is removed from the desired sites in the preform by physical deformation of the preform material. In the case of a preform body formed from polymeric material, this can be assisted by providing the preform in a partially unpolymerised state and/or by heating of the preform.

In another possible embodiment, chemical removal of the polymer may be used, either in conjunction with the aforementioned techniques or as an alternative thereto. For example, a series of injectors may issue small droplets of a solvent to assist entry of the pins or drill into the polymer material.

The method of the present invention is particularly suitable for producing either polymer or glass holey fibres. It allows not only rapid prototyping and testing for various arrays of holes but has been found as an efficient production technique in itself, particularly for producing relatively small volumes of speciality fibres. In particular, the process can be used with preform bodies of relatively large cross-section, and indeed such large preforms increase the accuracy of the physical/chemical removal of the polymer material and hence the quality of the resultant optical fibre drawn from the preform.

Preform materials suitable for use with the present invention include, but are not limited to:
PMMA (polymethylmethacrylate)
polycarbonate
polystyrene
condensation polymers
catalytically formed polymers
biopolymers
sol-gel polymers
chain addition polymers
fluropolymers
silica
“soft” glasses, such as fluoride glass and chalcoginide glasses.

In one embodiment of the invention the removal of material at predetermined sites in the body may be achieved by mechanical drilling utilising rotating drills. For example, holes of different sizes, but generally of the order of 1 mm in diameter, can be drilled into the body of the preform to a depth of the order of 10 cm. In one example, the inventors have achieved 1 mm diameter holes with interstitial thickness of approximately 200 microns. As such, this allows a much finer structure and increases design flexibility. The drilling step may be automated, so that a particular array of holes can be programmed into a drilling machine. As should be appreciated, the drilled holes in a preform do not necessarily have to be of the same size.

Using a sonic drill, with the drill head vibrating at sonic speeds, holes of the order of 1 mm in diameter can be drilled into preforms. One advantage of sonic drills over rotating drills is that, in principle, holes of almost any desired shape can be formed.

Typically, preforms usually have a diameter of about 15 mm, but more complex hole structure can be achieved by starting with a larger preform, such as 50 to 100 mm diameter or larger. Much larger preforms can be drawn into fibre (potentially in a multi-stage process) by flowing hot gas through the hole structure, achieving an almost uniform heating (a hot spot can then be created with additional localised external heating or cooling). If necessary, this air-flow technique can be used to stretch the preform to a desired (smaller) outer diameter, which can then be drawn in the usual fashion.

A further advantage of the present invention is that it makes the demonstration of polymer holey fibres with simple hole structures possible. Different hole structures can be fabricated with relative ease, and the method allows a great deal of control and repeatability to the extent that the process of fabricating a preform can be automated.

Advantageously, the method of the present invention allows the fabrication of preforms with different sizes for different holes. Furthermore, the hole structure is not restricted to a particular lattice structure. Another advantage of material removed from the preform is that it avoids the need for fusing or capillaries, which can be problematic, and reduces the total surface area by eliminating the need for interstitial holes. By using relatively thick preforms, for example of the order of 50-100 mm or larger in diameter, it is conceivable to make large complex preform structures by material removed. A thick preform can be short, since it draws to long lengths of fibre, so that the holes in the body do not need to be very deep.

Furthermore, because of the higher drawing ratio used in large preforms, the effects of surface defects and impurities will be correspondingly reduced. For example, by reducing the cross-section of the preform by a factor of X, surface defects will be correspondingly reduced by a factor of 1/X.

In a further development, inserts of a predetermined cross-sectional shape may be placed in the holes in the preform prior to drawing the preform. This technique can be employed to improve the accuracy of the whole structure in the fibre. After a hole is produced in the preform, a rod or wire of a predetermined shape is inserted and the preform collapsed around it by heating together with pressure or tension. This can be used to improve the uniformity of the inner holes or change their shape. For example, the applicant has tested this technique by inserting wires into the holes during the draw down process. The wires could be easily removed after the drawing of the fibre. By retaining the inserts in the holes during the annealing step, annealing can occur without incurring distortion to the hole structures.

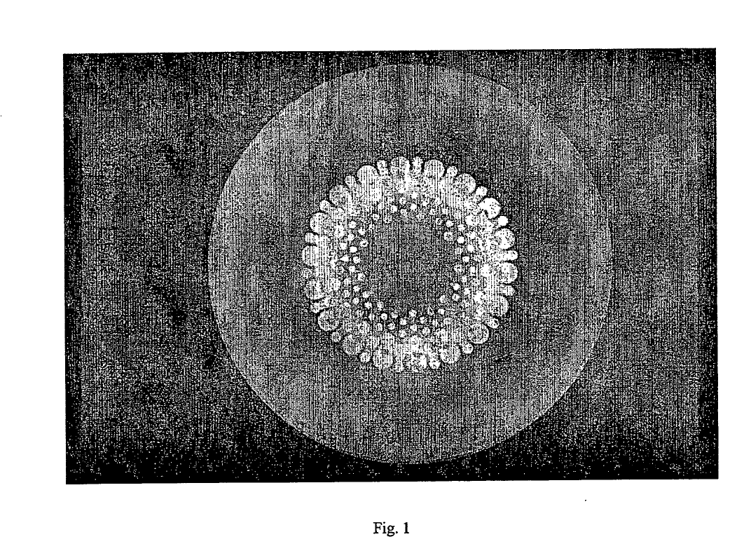

FIG. 1 illustrates a preform fabricated in accordance with the present invention. The preform has holes drilled into it, positioned in strategically predetermined chosen locations, not restricted to any particular lattice structure or hole-spacing. The holes have differing diameters in the range from 1 to 5 mm.

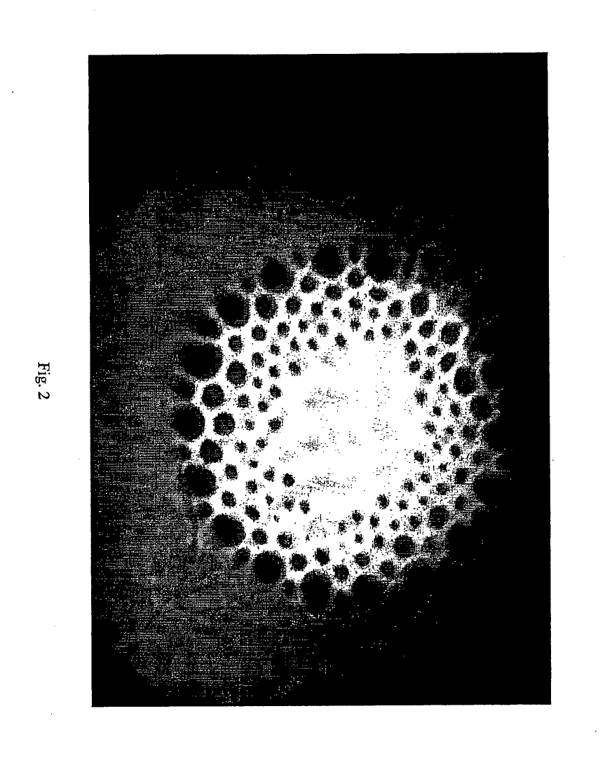

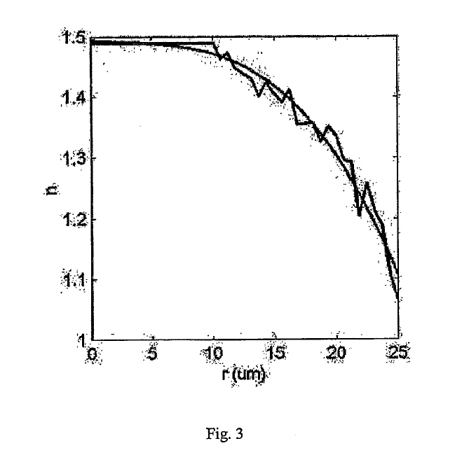

FIG. 2 illustrates the corresponding fibre, drawn from this preform. The fibre is capable of guiding light in a multimode fashion with a large spot size (about 40 microns in this case). The hole positions and sizes in the fibre give rise to a graded refractive index profile as shown in FIG. 3. This refractive index profile is calculated by taking the azimuthal average of the refractive index of the fibre (averaging the index over 360 degrees for a given distance from the centre), using the argument that if the holes are small enough in the fibre, the guided light will not be able to resolve the precise hole structure, but will rather experience an averaged structure. The graded index profile is important since it can be designed to compensate for modal dispersion, and thereby increase the communication bandwidth of the fibre. Achieving this with a hole structure provides a very cheap way of making graded index fibre.

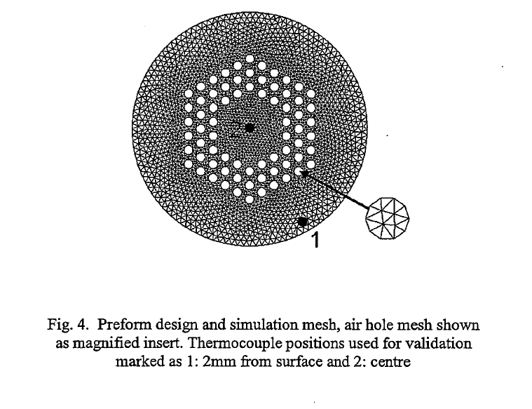

The inventors conducted a series of experiments to study the effects of the preform structure on the heating of the preform. FIG. 4 illustrates the design of the preform which was the subject of the experiments. The design comprised a simple hexagonal arrangement of holes with three rings that yielded a multimode fibre when drawn.

To study heat transfer in an MPOF preform, a finite element program was used to simulate the heating of both a solid and an air-structured preform. Radial heat transfer was simulated across the preform using a 2-dimensional, time-dependent conduction model where the preform was assumed to be infinitely long. Note that this modelling work allowed for an arbitrary air hole array to be included in the preform structure. The time dependent heat equation is expressed in Equation (1) below:

$$ρ {c}_{p} \frac{\partial T}{\partial t} = ∇ \cdot ( k ∇ T ) \qquad ( 1 )$$

The boundary condition at the surface of the preform is shown in Equation (2) below. The external temperature (Tₑₓₜ) was set to the measured furnace air temperature (130° C.), with an initial preform temperature of 24° C. Radiative heat transfer was also taken into account at the boundary along with convection. In this simplified model, the contribution of internal radiative heat transfer within the PMMA was neglected.

$$- k \frac{\partial T}{\partial n} = h ( T - {T}_{ext} ) + σɛ ( {T}^{4} - {T}_{ext}^{4} ) \qquad ( 2 )$$

The physical properties for PMMA and air are listed in Table 1 below. Note that the thermal conductivity for PMMA was adjusted to fit the experimental results, as no measured data was available for the specific grade of PMMA material used, the value is of the same order of magnitude as that reported in the literature for PMMA. An estimated value of 8 W/mK was used for the external heat transfer coefficient.

TABLE 1
Physical properties

| Material | PMMA | Air |
|---|---|---|
| Density ρ [kg/m³] [14] | 1170 | 0.93 |
| Specific heat C_{P} [J/kgK] [14] | 1380 | 1010 |
| Thermal conductivity k | 0.15 | 0.032 |
| [W/mK] | | |
| Emissivity ε [12] | 0.96 | |

Computational software can be used to solve the heat conduction equation. The equation was discretized using a finite element method. Variable time step sizes were used—from 0.5s at the beginning, where the temperature changes were the greatest, to 400 s as the preform moved towards its thermal equilibrium, totalling some 130 steps for a heating period of five hours. Due to the complex air hole structure, a non-uniform grid was employed.

In order to validate the numerical results, two MPOF preforms were prepared from 5 cm diameter PMMA. The first was a solid PMMA preform with a pattern of holes into which T-type thermocouples were embedded to measure the temperature at various positions. The second was an MPOF preform with an identical pattern of thermocouple holes used for the solid case, as shown in FIG. 4. The two thermocouple positions used for comparison with the numerical model are shown in FIG. 4.

In both cases, the total length of the preform was 140 mm and the thermocouple holes extended down to 70 mm. The MPOF preform holes were each 2 mm in diameter and extended all the way through the preform. These were closed off at the ends to minimise the impact of the external temperature on the results.

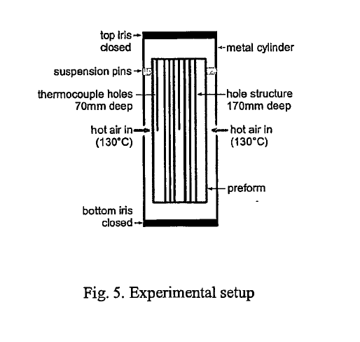

FIG. 5 illustrates the experimental set up used in the trials. A metal cylinder was hung within the oven chamber and hot air blown in via a ring of holes situated near the centre. The preform was suspended in the metal cylinder using plastic pins so that the ends of the thermocouple holes lay in the same plane as the hot air inlet. Holes in the top iris allowed the thermocouple wires to exit the oven for data logging.

A temperature lower than the draw temperature was used so that the preform did not deform in the process. The oven temperature was set at 130° C. while each preform was heated up over a period of two hours. The heating was very efficient in that the air temperature reached its set value in about two minutes from room temperature.

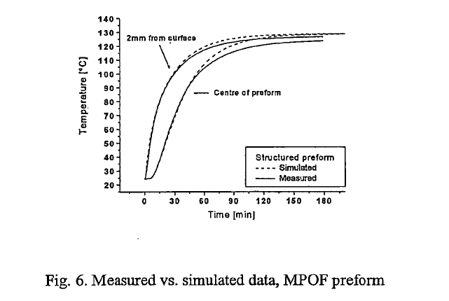

The simulated temperatures showed good agreement with the measured values, except that the latter steadied out to a lower temperature than the oven air temperature. Modelling studies where the finite length of the preform was taken into account showed that this effect was due to heat losses from the preform top end, which was exposed to a lower air temperature. The initial heating-up phase, however, agreed well with the simplified model, which could be used to study the effect of various air structures. FIG. 6 shows a comparison between simulated and measured data in the case of a structured preform.

The numerical results were also checked against an analytical solution for the heating of an infinite cylindrical solid rod—excellent agreement being obtained. All numerical results were shown to be insensitive to the type of element employed in the meshing procedure.

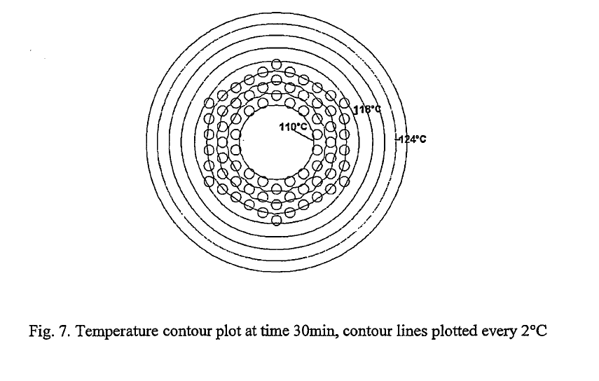

Referring to FIG. 7, two simulations were conducted to study the effect of air structures—a solid rod and a structure with 73 holes. A typical temperature contour plot for the structured case is also shown in FIG. 7, which shows that the hexagonal air hole pattern only causes a slight distortion to the internal temperature contour.

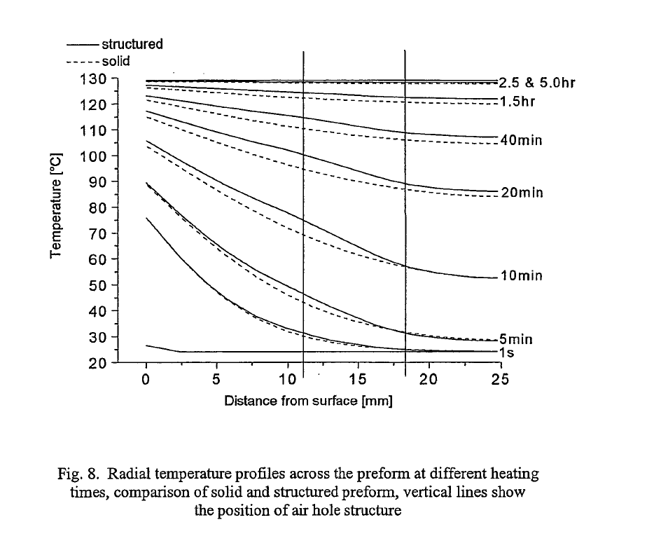

FIG. 8 shows a more detailed comparison of the solid and structured preform heating process. The effect of the air holes can be clearly seen after five minutes. The temperature in the outer part of the preform rises, relative to the solid case, as the air holes act as a resistive heat barrier. Note that the entire structured preform heats up more quickly with time than the solid case. The relatively low thermal capacity of the air (which meant that the heat transfer across the holes was always essentially at steady-state) and the fact that the structured preform contains less PMMA than the solid case, resulted in a faster dynamic response in the central portion of the structured preform.

External heating means that the outer part of the preform would reach the draw temperature some time before the central part—in fact, this study was carried out due to concerns that the presence of a hole structure might significantly slow down the process of bringing the core region up to the draw temperature. In order to avoid this situation alternative heating, such as radiative heating falling within the absorption bands of the material, may be employed.

Heat transfer within a structured PMMA preform was simulated using a numerical model, which was validated by experimental results. Despite the relatively low temperatures, radiative heat transfer to the preform was necessary within the model. The effect of the air holes on the heat transfer led to the control core region heating up more rapidly than the solid preform case.

Although the invention has been described with reference to specific examples it will be appreciated by those skilled in the art that the invention may be embodied in many other forms.

1. A method of producing an optical fibre, said method comprising applying heat to the interior of a preform and subsequently drawing said optical fibre from said preform.

2. A method of producing an optical fibre, said method comprising preparing a preform comprising a body of optically suitable material and removing material at predetermined locations in the body so as to provide a plurality of holes within the body, applying heat to the interior of the preform and subsequently drawing said optical fibre from said preform.

3. The method as claimed in claim 1 or 2 wherein the preform is of a relatively large diameter.

4. The method as claimed in claim 3 wherein the diameter of the preform is 50 mm or greater.

5. The method as claimed in any one of claims 1 to 4 wherein the preform includes one or more holes which facilitate the heating of the interior of the preform.

6. The method as claimed in claim 5 wherein said one or more holes in the preform permit the ingress of a heating fluid into the preform to facilitate the heating of the interior of the preform.

7. The method as claimed in claim 5 or 6 wherein the holes in the preform have parallel axes and extend parallel to the principal axis of the preform.

8. The method as claimed in any one of claims 2 to 6 wherein the holes extend through the preform.

9. The method as claimed in claim 6 wherein the heated fluid passes through the preform so as to heat the interior of the preform.

10. The method as claimed in any one of claims 6 to 9 wherein the heating fluid is a gas.

11. The method as claimed in any one of claims 6 to 9 wherein the heating fluid is a liquid.

12. The method as claimed in any one of claims 1 to 11 wherein the preform is formed from a polymer material.

13. The method as claimed in any one of claims 1 to 11 wherein the preform is formed from a glass material.

14. The method as claimed in claim 1 or 2 wherein heating of the interior of the preform is achieved by the application of lasers, microwaves, infrared or other forms of electromagnetic radiation.

15. The method as claimed in claim 14 wherein the heating is achieved by the application of a plurality of lasers configured such that intersecting beams from the lasers produce a higher intensity of heating at the centre of the preform.

16. A method of producing a polymer optical fibre, said method comprising drawing said optical fibre from a preform wherein both an exterior surface and interior of the preform are heated to assist in drawing the preform.

17. A method of preparing a preform for a holey fibre comprising providing a body of optically suitable material and removing material at predetermined locations in the body so as to provide a plurality of holes within the body.

18. The method as claimed in claim 17 wherein said holes are mutually parallel longitudinally extending holes arranged generally around the fibre axis.

19. The method as claimed in claim 16 wherein a first stage preform is heated and drawn to a second stage preform of reduced cross-section.

20. The method as claimed in claim 16 comprising a series of draws of the preform to successively reduce the cross-section of the preform.

21. The method as claimed in claim 20 further including the step of sleeving the preform between draws so as to produce a fibre with a microstructure of desired dimensions.

22. The method as claimed in claim 17 wherein the holes in the preform are heated by pins or protrusions.

23. The method as claimed in claim 17 wherein the pins are heated and inserted into the holes in the preform to produce the desired temperature gradient across the preform to facilitate the subsequent drawing process.

24. The method as claimed in claim 23 wherein pins or protrusions can form part of a mould in which the first stage preform is cast.

25. The method as claimed in claim 1 or 2 wherein a relatively large diameter initial preform is heated both internally, using holes in the preform to duct hot air, and locally from the outside, which is then drawn down to second stage preform.

26. The method as claimed in any one of the preceding claims wherein there is a relatively high drawing ratio in drawing the preform to form said optical fibre.

27. The method as claimed in claim 17 wherein the holes are formed by drilling.

28. The method as claimed in claim 17 wherein the holes are formed by sonic drilling.

29. The method as claimed in claim 17 wherein the holes are formed by laser.

30. The method as claimed in claim 17 wherein the holes are formed by punching.

31. The method as claimed in claim 17 wherein the material is chemically removed at predetermined locations in the body so as to provide a plurality of holes within the body.

32. The method as claimed in any one of the preceding claims wherein the hole structure is not restricted to a particular lattice structure.

33. The method as claimed in any one of the preceding claims wherein after a hole is produced in the preform, a rod or wire of a predetermined shape is inserted and the preform collapsed around it by heating together with pressure or tension.

34. A preform formed according to the method defined in any one of claims 1 to 33.

35. A preform formed according to any one of claims 1 to 33 wherein a plurality of holes are formed in the preform in predetermined locations, said holes having predetermined diameters, such that upon drawing of the preform the resulting fibre guides light in a multi-mode manner, the hole positions and sizes in the fibre resulting in a graded refractive index profile.
